(19) United States
(12) Patent Application Publication
(10) Pub. No.: US 2003/0053629 A1
(43) Pub. Date: Mar. 20, 2003

(54) USB authentication interface

(75) Inventor: Geert Arnold Knapen, San Jose, CA (US)

Correspondence Address: Corporate Patent Counsel, U.S Philips Corporation, 580 White Plains Road, Tarrytown, NY, 10591, US

(73) Assignee: Koninklijke Philips Electronics N.V.

(21) Appl. No.: 09/952,924

(22) Filed: Sep. 14, 2001

(51) Int. Cl. H04L 9/00

(52) U.S. Cl. 380/277

(57) ABSTRACT

A sequence of transmissions is encrypted as a set of sub-sequences, each sub-sequence having a different session key. The transmitting device determines when each new session key will take effect, and transmits this scheduled new-key-start-time to the receiving device. In a preferred embodiment, the transmitting device also transmits a prepare-new-key command to the receiving device, to provide a sufficient lead-time for the receiving device to calculate the new session key. Each new key is created using a hash function of a counter index and a set of keys that are determined during an initial key exchange session between the transmitting device and the receiving device. The counter index is incremented at each scheduled new-key-start-time, producing the new session key.

### BACKGROUND OF THE INVENTION

1. Field of the Invention

This invention relates to the field of computing systems, and in particular to computing systems that utilize a cryptographic protocol for communicating protected content material via a Universal Serial Bus (USB).

2. Description of Related Art

The use of cryptography for encoding electronic content material continues to increase. In the entertainment field, digital audio and video recordings are encrypted to protect the material from unauthorized copying. In the communications field, documents are encrypted to prevent unauthorized viewing, and encrypted certificates are used to verify the authenticity of a document.

A number of standards have been adopted or proposed for encrypting copyright content material, or security items such as tickets that are associated with access to the copyright content material, each time the material is transferred from one device to another. For example, when a “compliant” CD-recorder creates a CD that contains a copy of copy-protected material, the recording will be cryptographically protected so that only a “compliant” CD-player will be able to render the material. “Compliant” devices are devices that enforce the adopted standard. If the original copy-protected content material has a “copy-once” copy limitation, the compliant CD-recorder will cryptographically mark the copy of this original with a “copy-never” notation. A compliant CD-recorder will recognize this “copy-never” notation and will not create a copy of this copy. If the material is copied by a non-compliant recorder, it will not contain the appropriate cryptographic item, and a compliant recorder or playback device will not record or render this copied material.

Compliant devices operate in cooperation with each other to prevent unauthorized access to protected content material using a variety of security techniques. The security techniques are provided to overcome the various schemes used to gain unauthorized access. One technique commonly employed is to encrypt the protected material using a different encryption key each time the material is communicated from one device to another. This unique key is termed the “session” key. This unique-session-key technique, however, requires that the session-key be communicated between the devices, and a secure means is required to transmit this session key. Typically, the transmitting device transmits an encrypted parameter or set of parameters that the receiving device can use to determine the session key. This encryption of the parameter is based on a public-key, of a public-private-key-pair that is associated with the receiving device. The receiving device uses the private-key of the public-private-key-pair to decrypt the parameter to generate the session key. Typically, the public-private-key-pair is provided to each compliant device by a “trusted authority”. The receiving device communicates the public key to the transmitting device over a public channel, without fear of a compromise of security, because the public key's sole function is to encrypt material for communication to the receiving device; it does not provide any useful information for decrypting material.

Despite these security measures, a variety of illicit attacks are commonly known than can be used to defeat these security measures. A number of these attacks often involve “replay” scenarios, wherein the attacker records prior communications between compliant devices and replays the communications to one or both of the compliant devices at a later session to convince one or both of the devices that the attacker's device is an authorized compliant device. Although techniques and protocols are available to defeat replay attacks, such as the Needham-Schroeder protocol, these protocols remain vulnerable to a compromise of the session key.

### BRIEF SUMMARY OF THE INVENTION

It is an object of this invention to provide a secure means for transferring content material from one device to another. It is a further object of this invention to provide a secure means of transferring content material that provides protection against a compromise of the session key.

These objects and others are achieved by encrypting a sequence of transmissions as a set of sub-sequences, each sub-sequence having a different session key. The transmitting device determines when each new session key will take effect, and transmits this scheduled new-key-start-time to the receiving device. In a preferred embodiment, the transmitting device also transmits a prepare-new-key command to the receiving device, to provide a sufficient lead-time for the receiving device to calculate the new session key. Each new key is created using a hash function of a counter index and a set of keys that are determined during an initial key exchange session between the transmitting device and the receiving device. The counter index is incremented at each scheduled new-key-start-time, producing the new session key.

### BRIEF DESCRIPTION OF THE DRAWINGS

The invention is explained in further detail, and by way of example, with reference to the accompanying drawings wherein:

FIG. 1 illustrates an example block diagram of an encryption system in accordance with this invention.

FIG. 2 illustrates an example block diagram of a decryption system in accordance with this invention.

FIG. 3 illustrates an example flow diagram of an encryption system in accordance with this invention.

Throughout the drawings, the same reference numerals indicate similar or corresponding features or functions.

### DETAILED DESCRIPTION OF THE INVENTION

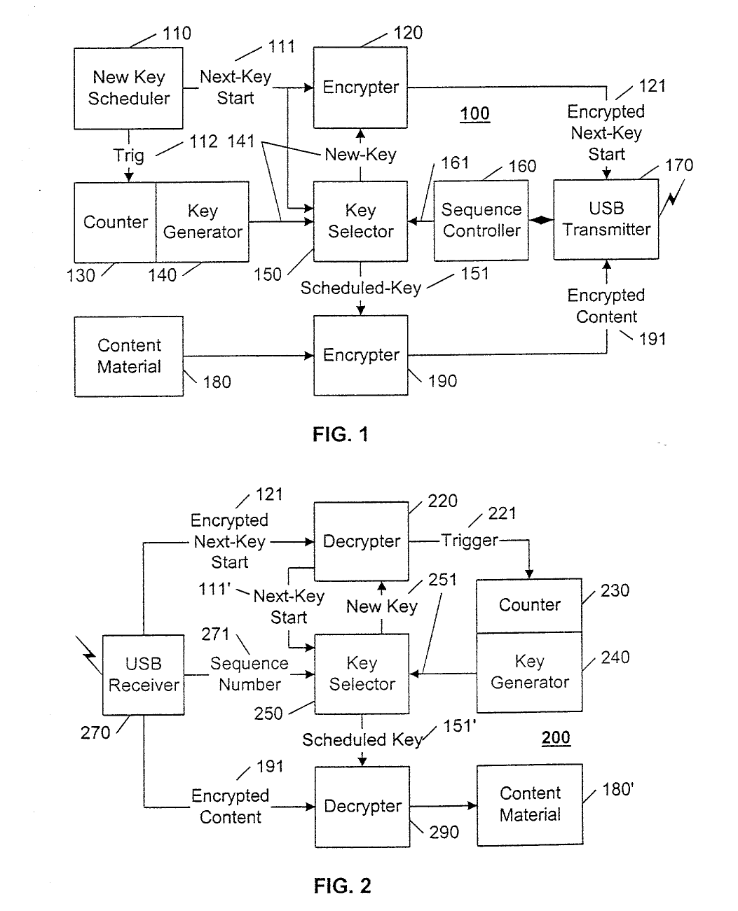

FIG. 1 illustrates an example block diagram of an encryption system 100 in accordance with this invention. The example encryption system 100 is illustrated as having a Universal Serial Bus (USB) transmitter 170 for communicating encrypted content material 191 to a decryption system (200 in FIG. 2), although, in view of this disclosure, one of ordinary skill in the art will recognize that the principles presented herein are applicable to other communication protocols as well. For ease of reference, and consistent with the USB protocol terminology, the encryption system 100 is termed the “host” 100, and the decryption system 200 is termed the “device” 200.

The host 100 is configured to encrypt content material 180, via an encrypter 190 that receives an encryption key from a key selector 150. The encryption key is referred to in FIG. 1 as a “scheduled key” 151, because, in accordance with this invention, the encryption key that is used to encrypt the content material 180 changes at discrete scheduled times. By changing the key that is used to encrypt the content material, the compromise of one of these keys will have a minimal effect on the security of the content material.

A new-key scheduler 110 is configured to trigger 112 the generation of a new key 141, and to determine the time 111 at which this new key will be utilized as the scheduled key 151 for encrypting the content material 180 at the encrypter 190. One of the difficulties with providing a scheduled time 111 for effecting an action at both the host 100 and the device 200, however, is the requirement that both systems 100, 200 are synchronized to the same time-base. In a preferred embodiment of this invention, the time-base is selected as an information item that is communicated from the host 100 to the device 200. In the context of the illustrated USB protocol embodiment, the time-base is defined as the “Frame number” of the communicated USB frame. The USB frame number establishes a time reference for all devices on the bus, and is communicated from the host to all devices on the bus every millisecond. The USB frame number consists of an 11-bit number that is contained in the transmitted frame that is incremented each millisecond. In the context of other protocols, similar time or sequence reference items may be utilized to establish a synchronization between the encryption system 100 and decryption system 200. Note that this common base need not be “time” based. In an asynchronous communication system, the base could be a packet number associated with each communicated packet, a block number associated with each block of data comprising the content material 180, or each block of encrypted data comprising the encrypted content material 191, and so on.

In a preferred embodiment, a key generator 140 corresponds to a modified Needham-Schroeder key generation device. Not illustrated, the key generator 140 uses the USB transmitter 170 to exchange random keys with the device 200, using a conventional Needham-Schroeder key exchange algorithm. Alternative key exchange techniques may be employed as well.

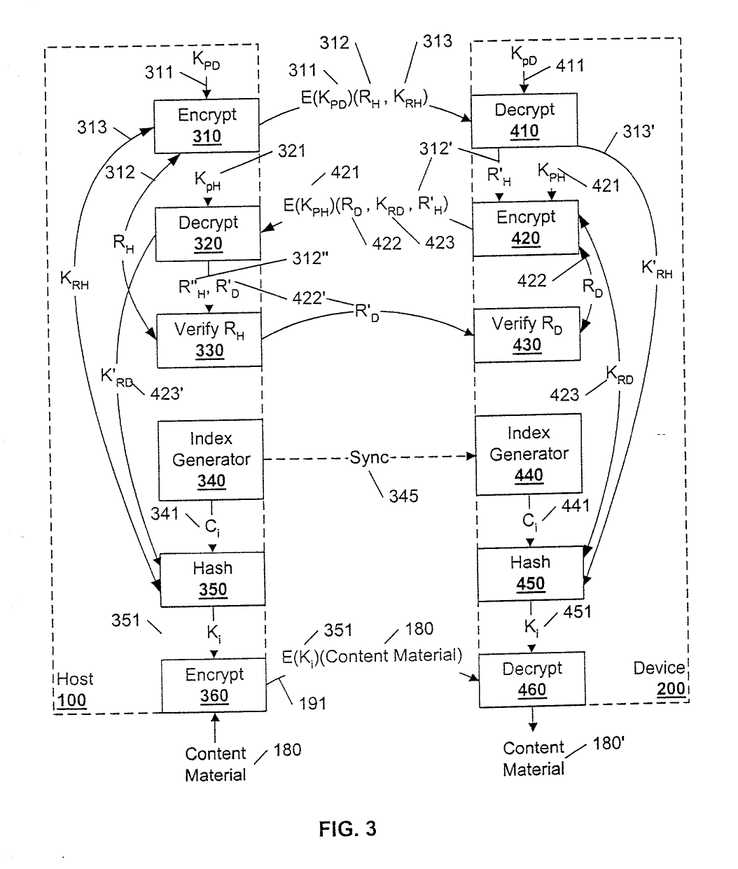

FIG. 3 illustrates an example flow diagram for a key exchange and subsequent encryption of content material using changing keys in accordance with this invention. At 310, the host (100) encrypts a host-random-number 312 and a host-random-key 313 using a device-public-key 311 that corresponds to a device-private-key 411 of a public-private (P-p) key pair associated with the device 200. The device 200 receives this encrypted host-random-number 312 and host-random-key 313 and decrypts them, at 410, using the device-private-key 411. The device 200 then encrypts, at 420, a device-random-number 422, a device-random-key 423, and the decrypted host-random-number 312′ using a host-public-key 421 that corresponds to a host-private-key 321 of a public-private key pair associated with the host 100, and communicates it to the host 100. The host 100 decrypts the device-random-number 422, the device-random-key 423, and the re-encrypted host-random-number 312′, using the host-private-key 321. By comparing the host-random-number 312 that was transmitted with the decrypted host-random-number 312″ that was received from the device 200, the host 100 is able to verify that the intended device is the device with which it is communicating. In like manner, the host 100 communicates the decrypted device-random-number 422′ to the device 200, so that the device 200 can verify that the transmitting system is the host that corresponds to the host-public-key 421. This exchange of random-numbers 312, 422 precludes a replay attack, wherein an imitation host or device merely replays one end of a recorded prior key exchange.

As is common in the art, but not illustrated, the aforementioned public-private key pairs are issued and certified by a “trusted authority”. That is, to prevent a non-compliant device from imitating a compliant device, the compliant device 200 sends its public key 311 to the host 100 along with a “certification” of the public key 311 by the trusted authority that issued the keys to the compliant device 200. The certification is an encryption that is based on a private-key of the trusted authority. The host decrypts the encryption based on the public-key of the trusted authority, and verifies that it corresponds to the provided public-key 311 of the receiving device 200. In like manner, the host 100 communicates its public key 421 to the device 200 along with a certification from the trusted authority for verification by the host 100. Also in a preferred embodiment, both the host 100 and device 200 have access to lists of revoked device or host keys.

At the completion of a key exchange, each system 100, 200 has knowledge of one or more secure keys. As is common in the art, the secure “keys” may be key-parameters that are used to generate the keys that are actually used within the cryptographic modules; for ease of reference, the term “key” is used herein to include such key-parameters. In the example key exchange of FIG. 3, each system 100, 200 has knowledge of the host-random-key 313 or 313′ and the device-random-key 423 or 423′, and an eavesdropper to the key exchange will not have this knowledge. As discussed above, the new key scheduler 110 of FIG. 1 is configured to trigger 112 the generation of new keys as the content material 180 is being encrypted. Although a new key-exchange session 310-410-320-420-330-430, detailed above, could be initiated upon receipt of each trigger 112 from the new key scheduler 110, such an approach would incur a significant amount of overhead with each new-key generation. In a preferred embodiment, each new key is created by hashing, at 350 and 450 of FIG. 3, a changing index 341, 351 with the one or more secure keys 313, 313′, 423, 423′ that were obtained via an original key exchange. The hashing function 350, 450 in a preferred embodiment is cryptographically robust, in that the amount of time required to “un-hash” the factors used to produce the hash value is substantially greater than the time required to produce the hash value from the given factors. Thus, a knowledge of the index 341, 351 does not provide an advantage in trying to deduce a new hash key value from a prior hash key value. Because a knowledge of the index 341, 351 does not provide a security advantage, a preferred embodiment of this invention utilizes a simple increment, or counting, function, to facilitate a new-key generation having minimal overhead.

As illustrated in FIG. 1, the new-key scheduler 110 triggers a counter 130 that provides a count value to the key generator 140 as the aforementioned index 341 that is hashed with one or more secure keys, and optionally other keys known to both the host and device, to produce the new-key 141. This new-key 141 is used to encrypt the next-key-start parameter 111 for transmission to the device 200, via the USB transmitter 170. As would be evident to one of ordinary skill in the art, this encryption, via the encrypter 120, provides an added level of security. Alternatively, albeit less secure, the next-key-start parameter 111 may be communicated in the clear, or secured by the prior key, and so on. In a preferred embodiment, the next-key-start parameter 111 is sufficiently far in the future to allow the device 200 to compute a corresponding new-key (241 in FIG. 2) before the encrypted content 191 that is encrypted with this new-key 141 is received by the device 200. The communication of the next-key-start parameter 111 from the host 100 to the receiver 200 constitutes the synchronization 345 between the index generators 340, 440 of FIG. 3.

As illustrated in FIG. 2, the encrypted next-key-start 121 is received by the USB receiver 270 and provided to a decrypter 220. The decrypter 220 generates a trigger signal 221 upon receipt of the encrypted next-key-start 121, to trigger the production of a new key 251 by the key generator 240. Alternatively, in a preferred embodiment, the host 100 transmits a “prepare-next-key” command, before it transmits the encrypted next-key start 121, to cause the trigger signal 221, thereby providing additional preparation time for the device 200 to generate the new-key 251. The device 200 includes a similar counter 230 and key generator 240 as in the host 100 to generate the same new-key as in the host 100 (351, 451 in FIG. 3) based on a hash of the secure keys and the index (441 in FIG. 3) provided by the counter 230.

The USB protocol allows for an isosynchronous communication mode, wherein the application using this mode is assured a minimal bandwidth. In accordance with this invention, the scheduled next-key-start 111 corresponds to a future frame sequence number. The sequence controller 160 and key selector 150 are configured to provide the new-key 141 as the scheduled key 151 such that the encrypted content 191 that is encoded by the prior key is completely transmitted before the scheduled frame number, and the encrypted content 191 that is encrypted by this new-key 141 is transmitted by the USB transmitter 170 at or after the scheduled frame number. The decrypter 220 in the device 200 provides this next-key-start parameter 111′ to the key selector 250. The USB receiver 270 communicates each frame sequence number 271 to the key selector 250. When the sequence number 271 equals or exceeds the next-key-start parameter 111′, the key selector 250 provides the new-key 251 as the scheduled key 151′. The decrypter 290 decrypts the encrypted content material 191 based on the scheduled key 151′ to produce the decrypted content material 180′, corresponding (if the secure keys correspond) to the transmitted content material 180.

The foregoing merely illustrates the principles of the invention. It will thus be appreciated that those skilled in the art will be able to devise various arrangements which, although not explicitly described or shown herein, embody the principles of the invention and are thus within its spirit and scope. For example, to minimize the complexity of the embodiment, the host 100 and device 200 can be configured to utilize a new key with each USB frame, or at a predetermined interval of USB frames, obviating the need to communicate a next-key start parameter 111 from the host 100 to the device 200. Independently, or in combination with this periodic key-change, the USB frame number 161 can be utilized directly as the index 341, 441 that is hashed with the secure keys to produce the new-key 141, 241. These and other system configuration and optimization features will be evident to one of ordinary skill in the art in view of this disclosure, and are included within the scope of the following claims.

I claim:

1. A method for communicating content material from a transmitter comprising:
determining a first session key, a second session key, and a scheduled start sequence number associated with the second session key,
encrypting a first portion of the content material based on the first session key to form a first sequence of encrypted content material for communication to a receiver before the scheduled start sequence number associated with the second session key,
communicating the scheduled start sequence number associated with the second session key to the receiver, and
encrypting a second portion of the content material based on the second session key to form a second sequence of encrypted content material for communication to the receiver at and after the scheduled start sequence number associated with the second session key.

2. The method of claim 1, further including:
receiving a key from the intended receiver, and wherein
determining the first session key and the second session key is based upon the key that is received from the intended receiver.

3. The method of claim 2, wherein
determining the first session key and the second session key is based upon a Needham-Schroeder public key exchange protocol.

4. The method of claim 1, wherein
the first session key corresponds to a first hash value that is based on a host key that is associated with the transmitter, a device key that is associated with the receiver, and a first index value, and
the second session key corresponds to a second hash value that is based on the host key, the device key, and a second index value.

5. The method of claim 4, wherein
the first hash value and the second hash value are further based on a second host key and a second device key.

6. The method of claim 1, wherein
the first sequence and second sequence of encrypted content material comprise sequences of frames that are communicated in accordance with a Universal Serial Bus (USB) protocol, and
the scheduled start sequence number corresponds to a USB frame number.

7. An encryption system that is configured to encrypt content material to provide encrypted content material for transmission to a decryption system comprising:
an encrypter that is configured to:
encrypt a first portion of the content material based on a first session key to form a first encrypted sequence,
encrypt a second portion of the content material based on a second session key to form a second encrypted sequence having a starting sequence number, and
a transmitter that is configured to
transmit the starting sequence number, the first encrypted sequence, and the second encrypted sequence to the decryption system.

8. The encryption system of claim 7, further including:
a key generator that is configured to provide the first session key and the second session key based on at least one key that is intended to be known to the encryption system and the decryption system only.

9. The encryption system of claim 8, wherein
the at least one key that is intended to be known to the encryption system and the decryption system only is communicated between the encryption system and the decryption system via a Needham-Schroeder key-exchange algorithm.

10. The encryption system of claim 8, wherein
the key generator is further configured to provide:
the first session key based on a hash of the at least one key and a first index value, and
the second session key based on the hash of the at least one key and a second index value.

11. The encryption system of claim 7, wherein
the transmitter is further configured to transmit the starting sequence number, the first encrypted sequence, and the second encrypted sequence based on a Universal Serial Bus (USB) protocol, and
the starting sequence number corresponds to a USB frame number.

12. The encryption system of claim 7, wherein
the transmitter is further configured to transmit the starting sequence number as an encrypted starting sequence number.

13. A decryption system comprising
a receiver that is configured to receive encrypted content material and a starting sequence number from an encryption system, and
a decrypted that is configured to
decrypt a first sequence of the encrypted content material before the starting sequence number based on a first session key, and
decrypt a second sequence of the encrypted content material at and after the starting sequence number based on a second session key.

14. The decryption system of claim 13, further including:
a key generator that is configured to provide the first session key and the second session key based on at least one key that is intended to be known to the encryption system and the decryption system only.

15. The encryption system of claim 14, wherein
the at least one key that is intended to be known to the encryption system and the decryption system only is communicated between the encryption system and the decryption system via a Needham-Schroeder key-exchange algorithm.

16. The encryption system of claim 14, wherein
the key generator is further configured to provide:
the first session key based on a hash of the at least one key and a first index value, and
the second session key based on the hash of the at least one key and a second index value.

17. The encryption system of claim 13, wherein
the receiver is further configured to receive the starting sequence number and the encrypted content material based on a Universal Serial Bus (USB) protocol, and
the starting sequence number corresponds to a USB frame number.
